(19) United States
(12) Patent Application Publication
(10) Pub. No.: US 2026/0034783 A1
(43) Pub. Date: Feb. 5, 2026

(54) LIQUID EJECTION HEAD AND LIQUID EJECTION APPARATUS

(71) Applicant: CANON KABUSHIKI KAISHA, Tokyo (JP)

(72) Inventor: MAKI KATO, Tokyo (JP)

(21) Appl. No.: 19/262,323

(22) Filed: Jul. 8, 2025

(30) Foreign Application Priority Data
Aug. 1, 2024 (JP) 2024-125777

(51) Int. Cl. B41J 2/14; G01N 27/12

(52) U.S. Cl. CPC B41J 2/14233; G01N 27/12; B41J 2002/14241; B41J 2002/14306; B41J 2002/14491

(57) ABSTRACT

A liquid ejection head includes: an ejection port from which a liquid is to be ejected; a first substrate including a liquid chamber communicating with the ejection port and having a communication port, and an energy generation element that generates energy for ejecting the liquid from the ejection port; a second substrate having a flow path communicating with the communication port of the liquid chamber and joined to the first substrate; and a sensing wire for sensing penetration of the liquid to an interface between the first substrate and the second substrate, the sensing wire being provided between the energy generation element and the communication port in a second direction parallel to a surface of the second substrate as viewed in a first direction corresponding to a direction, in which the first substrate and the second substrate are stacked in layers, to sense penetration of the liquid.

### BACKGROUND

### Field of the Technology

The present disclosure relates to a liquid ejection head and a liquid ejection apparatus.

### Description of the Related Art

Conventionally, as a liquid ejection apparatus, a configuration including a liquid ejection head that ejects a liquid such as ink to record an image onto a recording medium has been known. In the liquid ejection head, it is possible to join a plurality of substrates together with an adhesive and form an ink flow path extending between the substrates. When an ejecting operation is repeated over a long period of time by using a liquid ejection head having such a configuration, it may be possible that a joined state between the substrates changes to result in delamination at interfaces between the substrates and the adhesive. As a result, ink may penetrate from the flow path to damage ejection elements and electric wiring each disposed on the substrates and result in defective ejection.

Japanese Patent No. 6213335 publication discloses a configuration in which, to prevent ink penetration, a metallic structure is provided at a position surrounding a communication port serving as a flow path, and an upwardly protruding annular wall portion is further provided.

However, no matter what the configuration is, it is difficult to completely prevent ink penetration. In the configuration described above, when the ink penetrates through a junction portion, defective ejection may occur.

### SUMMARY

The present disclosure is directed to provide a liquid ejection head that can suppress occurrence of defective ejection.

According to some embodiments, a liquid ejection head of the present disclosure is characterized by features including:
an ejection port from which a liquid is to be ejected;
a first substrate including a liquid chamber communicating with the ejection port and having a communication port, through which the liquid to be supplied to the liquid chamber passes, and an energy generation element that generates energy for ejecting the liquid from the ejection port;
a second substrate joined to the first substrate, the second substrate having a flow path communicating with the communication port of the liquid chamber; and
a sensing wire for sensing penetration of the liquid to an interface between the first substrate and the second substrate, the sensing wire being provided between the energy generation element and the communication port in a second direction parallel to a surface of the second substrate as viewed in a first direction corresponding to a direction in which the first substrate and the second substrate are stacked in layers.

According to the present disclosure, it is possible to provide a liquid ejection head that can suppress occurrence of defective ejection.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating a schematic configuration of a liquid ejection apparatus according to an embodiment;

FIG. 2 is a perspective view illustrating a schematic configuration of a liquid ejection head according to the embodiment;

FIG. 3 is a block diagram illustrating a configuration of a control system of the liquid ejection apparatus according to the embodiment;

FIG. 4 is a cross-sectional view of a liquid ejection head substrate according to the embodiment;

FIG. 5 is a plan view of an element substrate according to a first example embodiment;

FIG. 6 is a cross-sectional view of the liquid ejection head substrate according to the first example embodiment;

FIG. 7 is a plan view of an element substrate according to a modification;

FIG. 8 is a plan view of an element substrate according to a second example embodiment; and

FIG. 9 is a cross-sectional view of a liquid ejection head substrate according to the second example embodiment.

### DESCRIPTION OF THE EMBODIMENTS

Referring to the drawings, the following will specifically describe an embodiment of the present disclosure. Note that components described in the following embodiment are only exemplary, and a configuration and various conditions of an apparatus to which the present disclosure is applied can appropriately be corrected or changed within the scope not departing from the gist of the present disclosure, and are by no means limited to the following embodiment. For example, dimensions, materials, shapes, relative positioning, and the like of components described in the following embodiment can appropriately be changed depending on the configuration of the apparatus and the various conditions to which the present disclosure is applied, and the present disclosure is not limited to the following embodiment unless particularly otherwise mentioned.

Note that, in the present description, “printing” (which may be referred to also as “typed words”, “recording”, or “print”) not only includes formation of significant information such as characters and graphics, but also broadly includes formation of images, figures, patterns, and the like on a recording medium or processing of the medium through ejection of a liquid, regardless of whether information is significant or insignificant and whether or not the information is visualized so as to be visually perceivable by humans.

### Embodiment

As an embodiment, a description will be given of an example in which the present disclosure is applied to a liquid ejection apparatus that ejects ink as a recording liquid to a recording medium such as a paper sheet to record an image and to a liquid ejection head included in the liquid ejection apparatus. However, the present disclosure is also applicable to a liquid ejection head that ejects a liquid other than ink and to another liquid ejection apparatus.

### Liquid Ejection Apparatus

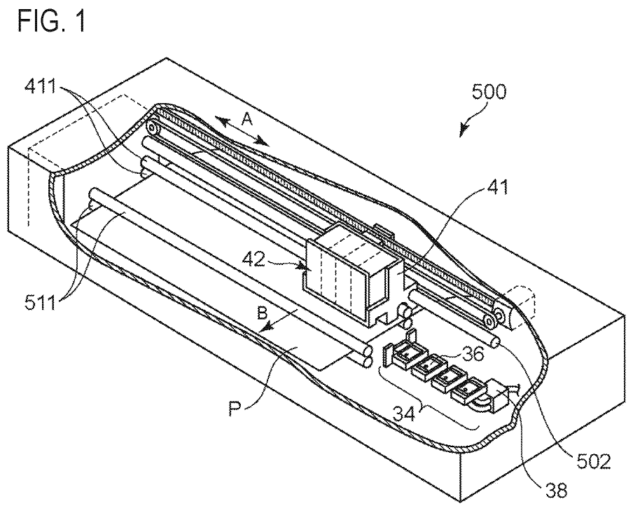

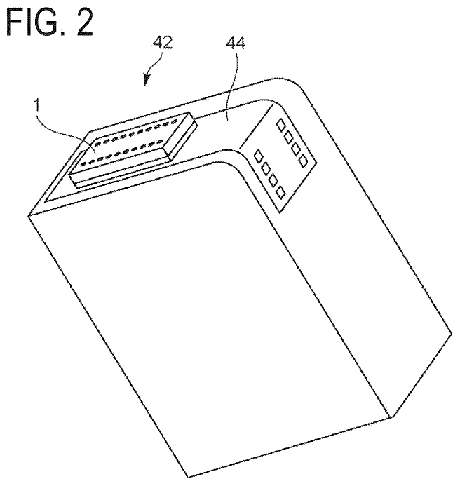

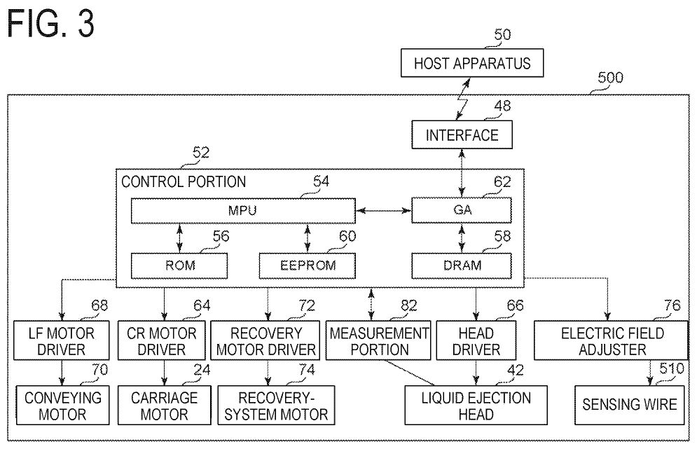

A description will be given of a liquid ejection apparatus 500 according to the embodiment. FIG. 1 is a perspective view illustrating a schematic configuration of a liquid ejection apparatus 500. FIG. 2 is a perspective view illustrating a schematic configuration of liquid ejection heads 42 provided in the liquid ejection apparatus 500. FIG. 3 is a block diagram illustrating a configuration of a control system of the liquid ejection apparatus 500.

The liquid ejection apparatus 500 is a recording apparatus including the liquid ejection heads 42 each of which ejects a liquid (ink) toward a recording medium P and a carriage 41 from which the liquid ejection heads 42 are detachable. The carriage 41 moves in a scanning direction A, while being supported on a guide shaft 502. With the movement of the carriage 41, the liquid ejection heads 42 also move together with the carriage 41 in the scanning direction A.

The liquid ejection apparatus 500 includes a conveying portion that conveys the recording medium P in a conveying direction B crossing the scanning direction A. The conveying portion is configured to include conveying members such as conveying rollers 411 and conveying rollers 511. The conveying rollers 411 and 511 are rotatively driven by a conveying motor 70 to convey the recording medium P in the conveying direction B. In the embodiment, the scanning direction A and the conveying direction B are substantially perpendicular to each other.

In the liquid ejection apparatus 500, while driving a carriage motor 24, a control portion 52 performs a recording operation of ejecting the ink onto the recording medium P according to recording data. Thus, an image corresponding to one band is recorded on the recording medium P. Then, the control portion 52 drives the conveying motor 70 to perform a conveying operation of conveying the recording medium P in the conveying direction B by a distance equivalent to the one band. In the liquid ejection apparatus 500, by thus repetitively alternating the recording operation and the conveying operation, an image to be recorded is formed on the recording medium P.

In addition, in the liquid ejection apparatus 500, the liquid ejection heads 42 include a recovery unit 34 for performing maintenance on the liquid ejection heads 42 at a home position located on one end portion in the scanning direction A. The recovery unit 34 includes cap members 36 for protecting the liquid ejection heads 42, a pump 38 that causes a negative pressure in the cap members 36 by suction, and the like. The four liquid ejection heads 42 are provided on the carriage 41 and configured to be able to respectively eject cyan ink, magenta ink, yellow ink, and black ink. To each of the liquid ejection heads 42, a liquid ejection head substrate 1 and an electric wiring member 44 for supplying the recording data, electric power, or the like are attached.

### Control System

Next, referring to FIG. 3, a description will be given of a control system of the liquid ejection apparatus 500. The liquid ejection apparatus 500 is connected to a host apparatus 50 provided separately via an interface (hereinafter referred to as I/F) 48. The liquid ejection apparatus 500 performs transmission/reception of various information to/from the host apparatus 50 via the I/F 48. Specifically, the liquid ejection apparatus 500 receives a recording command and image data from the host apparatus 50 via the I/F 48 and transmits status information of the liquid ejection apparatus 500 to the host apparatus 50. As the host apparatus 50, not only a versatile personal computer, but also a known apparatus such as a digital camera, a scanner, or a mobile terminal can be used. When a recording command is generated in the host apparatus 50, the recording command is input together with image data to the liquid ejection apparatus 500 via the I/F 48.

The control portion 52 controls an overall operation of the liquid ejection apparatus 500. The control portion 52 includes an MPU 54, a ROM 56, a DRAM 58, an EEPROM 60, and a gate array (hereinafter referred to as GA) 62. The EEPROM 60 is a memory for recording various information required for the liquid ejection apparatus 500 when a power source is subsequently turned ON even in a state where the power source is turned OFF. The GA 62 performs data transfer control to/from the I/F 48 on the basis of an instruction from the MPU 54.

The MPU 54 performs various processing according to programs and parameters each stored in the ROM 56, while using the DRAM 58 as a work area. For example, the MPU 54 drives the carriage motor 24 via a CR motor driver 64 connected to the control portion 52 to move the carriage 41 in the scanning direction A. In the recording operation, at this time, the recording data is transferred from the DRAM 58 to the liquid ejection heads 42 via a head driver 66 connected to the control portion 52, and the image corresponding to the one band is recorded on the liquid ejection head 42.

In addition, the MPU 54 drives the conveying motor 70 via an LF motor driver 68 connected to the control portion 52 every time the image corresponding to the one band is recorded to convey the recording medium P by a predetermined distance in the conveying direction B by using the conveying rollers 411 and 511. The liquid ejection apparatus 500 alternately repeats the recording operation by the MPU 54 under the control of the carriage motor 24 and the liquid ejection head 42 and the conveying operation by the MPU 54 under the control of the conveying rollers 411 and 511 to record the image data received from the host apparatus 50 onto the recording medium P.

Furthermore, the MPU 54 drives a recovery-system motor 74 via a recovery motor driver 72 connected to the control portion 52 with timing after the recording of the image equivalent to one page is ended to thereby perform suction recovery processing on the liquid ejection heads 42. In other words, the recovery-system motor 74 includes a motor for driving the pump 38 and a motor for driving (e.g., raising and lowering) the cap member 36.

The MPU 54 also adjusts a potential in sensing wires provided on the liquid ejection head 42 via an electric field adjustor 76 connected to the control portion 52. Meanwhile, a measurement portion 82 measures a resistance value in a wiring circuit for sensing ink penetration in the liquid ejection head 42 and outputs a result of the measurement to the control portion 52. Note that the sensing wires for sensing ink penetration will be described later.

In the ROM 56, various parameters to be used by the MPU 54 to perform various control are stored. Examples of such parameters include a shape of a voltage pulse to be applied to piezoelectric elements of the liquid ejection head 42, a speed of conveyance of the recording medium P, a speed of movement of the carriage 41, and the like.

### Liquid Ejection Head

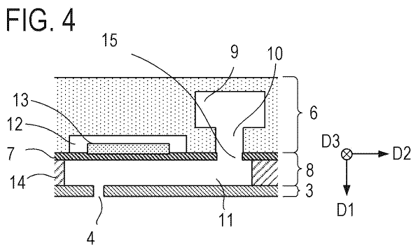

Next, a description will be given of a configuration of the liquid ejection head 42. FIG. 4 is a cross-sectional view of the liquid ejection head substrate 1 of the liquid ejection head 42 according to the embodiment. The liquid ejection head substrate 1 is configured to include an element substrate 8 (first substrate), a flow path formation substrate 6 (second substrate), and a nozzle substrate 3 (third substrate) which are stacked in layers. In an attitude in which the liquid ejection head 42 is used, the nozzle substrate 3, the element substrate 8, and the flow path formation substrate 6 are stacked in layers in this ascending order from the lower layer (bottom).

In the following description, it is assumed that a direction in which the element substrate 8, the flow path formation substrate 6, and the nozzle substrate 3 are stacked is a first direction D1. It is also assumed that a predetermined direction crossing the first direction D1 is a second direction D2 and a direction crossing each of the first direction D1 and the second direction D2 is a third direction D3. In the embodiment, the first direction D1, the second direction D2, and the third direction D3 are perpendicular to each other. FIG. 4 illustrates a cross section of the liquid ejection head substrate 1 as viewed in the third direction D3. The following will describe positional relationships between individual members on the basis of an attitude in which the first direction DI is vertically parallel, the flow path formation substrate 6 is located over the element substrate 8, and the nozzle substrate 3 is located below the element substrate 8, as illustrated in FIG. 4.

In the nozzle substrate 3, ejection ports 4 from which the ink is to be ejected are formed. The plurality of ejection ports 4 are formed in the nozzle substrate 3 to function as nozzles for ejecting the ink toward the recording medium P. A direction in which the ink is ejected from each of the ejection ports 4 is substantially parallel to the first direction D1.

In the element substrate 8, pressure chambers 11 are formed. Each of the pressure chambers 11 is a liquid chamber (flow path) communicating with the ejection port 4 and having the inside through which the ink ejected from the ejection port 4 passes.

In the flow path formation substrate 6, a common flow path 9, individual flow paths 10, and cavities 12 are formed. The individual flow paths 10 are flow paths communicating with the pressure chamber 11, while the common flow path 9 is a flow path communicating with the individual flow paths 10. The cavities 12 are spaces in which piezoelectric elements 13 are to be placed, and are provided at positions overlapping the individual flow paths 10 when viewed in the second direction D2.

In the liquid ejection head substrate 1, a liquid flow path configured to include the common flow path 9, the individual flow paths 10, the pressure chambers 11, and the ejection ports 4 is formed. The ink supplied from a liquid containing portion or the like passes through the common flow path 9, the individual flow path 10, and the pressure chamber 11 in this order inside each of the liquid ejection heads 42 to be ejected from the ejection port 4.

On the element substrate 8, a diaphragm 7 is placed. The diaphragm 7 is an insulating film formed of an elastic material, such as silicon dioxide. The diaphragm 7 is provided on outermost surface of the element substrate 8 to be joined to the flow path formation substrate 6. The diaphragm 7 is also included, together with pressure chamber walls 14 of the element substrate 8, in inner wall surfaces of the pressure chambers 11. In other words, the diaphragm 7 is formed with a surface facing the inside of the pressure chamber 11 and with a surface facing the outside (flow path formation substrate 6 side) of the element substrate 8. The surface facing the flow path formation substrate 6 side of the diaphragm 7 is an outermost surface of the element substrate 8, which is a junction surface to be joined to the flow path formation substrate 6.

On the surface of the diaphragm 7 facing the flow path formation substrate 6 side, the piezoelectric element 13 corresponding to the pressure chamber 11 is placed. In a state where the element substrate 8 and the flow path formation substrate 6 are joined together, each of the piezoelectric elements 13 is placed inside the cavity 12 formed in the flow path formation substrate 6.

When electric power is applied to the piezoelectric element 13, the piezoelectric element 13 is deformed so as to warp toward the inside of the pressure chamber 11. With the deformation of the piezoelectric element 13, the diaphragm 7 is deformed integrally with the piezoelectric element 13 to reduce a capacity of the pressure chamber 11, while a pressure is applied to the ink in the pressure chamber 11. When the pressure is applied to the ink in the pressure chamber 11, the ink is partly ejected as droplets (ink drops) from the ejection port 4. In other words, the piezoelectric element 13 is an energy generation element for causing the ink in the pressure chamber 11 (in the liquid chamber) to be ejected from the ejection port 4. The piezoelectric element 13 is provided to correspond to the ejection port 4 and disposed at a position overlapping the ejection port 4 when viewed in the first direction D1.

In the surface of the element substrate 8 formed with the piezoelectric element 13, i.e., the surface of the diaphragm 7, a communication port 15 for allowing the pressure chamber 11 to communicate with the individual flow path 10 is formed. The element substrate 8 and the flow path formation substrate 6 are aligned and joined together with an adhesive such that each of the communication ports 15 of the element substrate 8 communicates with the individual flow path 10 of the flow path formation substrate 6. At this time, an outer edge portion of the communication port 15 is joined to the flow path formation substrate 6.

The communication ports 15 are openings (flow paths) formed in the diaphragm 7, and other members such as the pressure chamber walls 14 are not included in wall portions of the communication ports 15. To increase a displacement efficiency, the diaphragm 7 is generally formed thin, and accordingly has a low mechanical strength and is easily damaged by an external force. Examples of the external force include deformation of the diaphragm 7 resulting from driving of the piezoelectric element 13 or the like. When the diaphragm 7 is damaged, the ink undesirably penetrates the element substrate 8 from the communication port 15 to reach the inside thereof.

Alternatively, a case may also be considered in which, as an unexpected event, leakage occurs in the flow path formation substrate 6 or the element substrate 8, and a potential is placed thereon. In general, an inner wall of the ink flow path is formed with a protection film but, when the ink flow path protection film has a defect, the ink may penetrate to cause an anodic reaction of the layer around the communication port due to an electrochemical reaction and cause oxidization and dissolution.

When such an event as described above has caused damage and the dissolution at a junction portion around the communication port 15, the ink penetrates the element substrate 8 to reach the inside thereof and come into contact with the piezoelectric element 13 formed on the element substrate 8 and a drive wire for driving the piezoelectric element 13. As a result, the electrochemical reaction causes corrosion and defective ejection.

The piezoelectric element 13 and the drive wire each formed on the element substrate 8 are covered with the protection film. However, the piezoelectric element 13 and the drive wire are formed on the junction surface of the element substrate 8 with the flow path formation substrate 6, and it is not assumed in the first place that the ink penetrates the element substrate 8 to reach the inside of the cavity 12 or the like. Consequently, the protection film alone may not be sufficient to protect the piezoelectric element 13 and the drive wire from the ink that penetrates as an unexpected event.

In preparation for such an event, it is preferable that, when the ink penetrates an upper surface of the element substrate 8, the penetration of the ink can be sensed before the ink reaches the piezoelectric element 13 and the drive wire. The following will describe a configuration for sensing the penetration of the ink, which is applicable to the embodiment, in several different example embodiments.

### First Example Embodiment

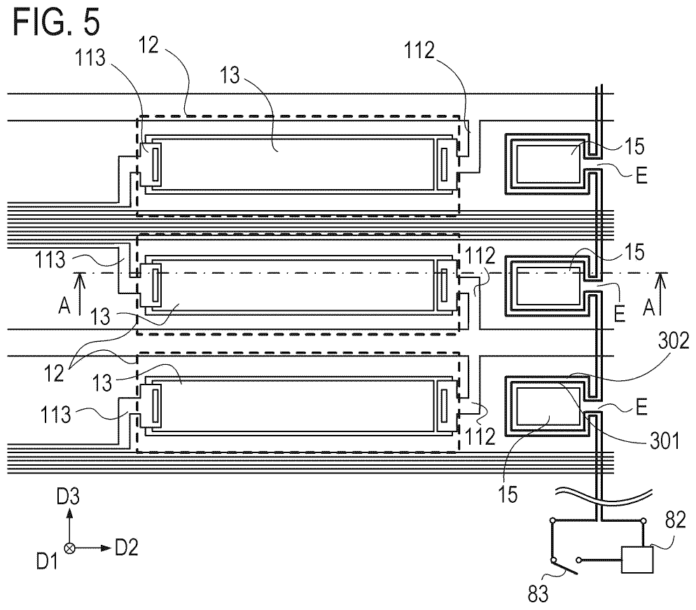

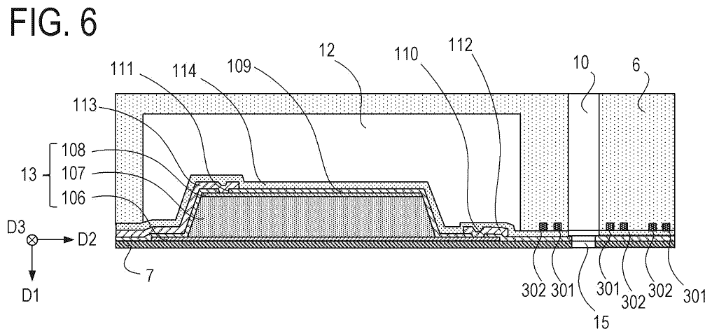

Referring to FIGS. 5 and 6, a description will be given of a first example embodiment including an ink penetration sensing configuration. FIG. 5 is a plan view illustrating the periphery of some of the piezoelectric elements 13 of the element substrate 8 according to the first example embodiment, which is a view when the element substrate 8 is viewed in the first direction D1. Note that, in FIG. 5, to clearly show positional relationships among members such as individual wires, illustration of some of the members, such as the protection film, is omitted. In addition, in FIG. 5, positions of the cavities 12 of the flow path formation substrate 6 are indicated by dotted lines.

Over the element substrate 8, the piezoelectric elements 13, the number of which corresponds to that of the plurality of ejection ports 4 in the nozzle substrate 3, are provided. When viewed in the first direction D1, the communication ports 15 are opened at positions arranged with respect to the individual piezoelectric elements 13 in the second direction D2. A cross-sectional shape (shape when viewed in the first direction D1) of each of the communication ports 15 is a rectangle having the second direction D2 as a longitudinal direction. FIG. 5 illustrates the three piezoelectric elements 13 and the three communication ports 15 which are disposed to be arranged in the third direction D3.

To the piezoelectric elements 13, as the drive wires for driving the piezoelectric elements 13, first drive wires 112 and second drive wires 113 are connected. Each of the piezoelectric elements 13 has a rectangular shape having long sides parallel to the second direction D2 and short sides parallel to the third direction D3 when viewed in the first direction D1. The first drive wires 112 are connected to end portions of the piezoelectric elements 13 which are closer to the communication ports 15 in the longitudinal direction. The second drive wires 113 are connected to end portions of the piezoelectric elements 13 which are more distant from the communication ports 15 in the longitudinal direction.

Between the two piezoelectric elements 13 adjacent to each other in the third direction D3, the first drive wire 112 or the second drive wire 113 extends. In FIG. 5, not only the drive wires connected to the piezoelectric elements 13 illustrated therein, but also the drive wires connected to the piezoelectric elements 13 not illustrated therein are illustrated. These drive wires extend in the third direction D3 so as to also pass between the two communication ports 15 adjacent to each other in the third direction D3.

Thus, with respect to the communication ports 15, the piezoelectric elements 13 and the first drive wires 112 are adjacent to each other in the second direction D2, while the first drive wires 112 and the second drive wires 113 are adjacent to each other in the third direction D3. When the ink penetrates the wires and the piezoelectric element 13 which are arranged around any of the communication port 15 via the communication port 15, there is a risk that defective ejection may occur. Accordingly, the first example embodiment uses a configuration in which the sensing wires for sensing the penetration of the ink to an interface between the element substrate 8 (first substrate) and the flow path formation substrate 6 (second substrate) are provided around the communication port 15.

In the first example embodiment, the liquid ejection head substrate 1 includes a first sensing wire 301 and a second sensing wire 302 as the sensing wires that sense the ink penetration. The first sensing wire 301 and the second sensing wire 302 are arranged parallel to be spaced apart from each other by a predetermined distance. In the first example embodiment, the first sensing wire 301 and the second sensing wire 302 extend so as to surround the plurality of communication ports 15, while maintaining a parallel positional relationship therebetween, and are connected to different electrode pads. In other words, the first sensing wire 301 and the second sensing wire 302 have a mutually electrically insulated relationship therebetween.

The liquid ejection head 42 also includes the measurement portion 82 as a measurement apparatus capable of measuring a resistance value of a circuit including the first sensing wire 301 and the second sensing wire 302. The measurement portion 82 is connected to the first sensing wire 301 and the second sensing wire 302 via the electrode pads. Note that the measurement portion 82 may also be provided not on the liquid ejection head 42, but on a main body side of the liquid ejection apparatus 500. In the first example embodiment, the measurement portion 82 measures a resistance value between the first sensing wire 301 and the second sensing wire 302.

When there is no ink penetration between the first sensing wire 301 and the second sensing wire 302, the first sensing wire 301 and the second sensing wire 302 are in an open state. Accordingly, the resistance value measured by the measurement portion 82 via the electrode pads is sufficiently large. The resistance value at this time is assumed to be a reference resistance value.

Meanwhile, when there is ink penetration between the first sensing wire 301 and the second sensing wire 302, the resistance value becomes lower than the reference resistance value. Therefore, with the configuration in the first example embodiment, it is possible to continuously measure the resistance value between the first sensing wire 301 and the second sensing wire 302 and determine that there is ink penetration in the element substrate 8 when the resistance value lowers.

In other words, according to the present example embodiment, it is possible to sense ink penetration at the time when the ink comes into contact with any of the sensing wires. Then, before the defective ejection occurs, it is possible to stop an ejecting operation and require head replacement of a user.

In addition, in a circuit configured to include the first sensing wire 301, the second sensing wire 302, and the measurement portion 82, a switch 83 is provided. The switch 83 may also be configured to be brought into an open state while the liquid ejection head 42 is printing and closed when the resistance value is to be measured. Alternatively, the switch 83 may also be configured to be in a constantly closed state and the measurement portion 82 constantly measures the resistance value.

Note that a role of a determination portion that determines ink penetration may also be performed by the control portion 52 of the liquid ejection apparatus 500, or the determination portions may also be provided separately on the respective liquid ejection heads 42. The determination portion may determine that there is ink penetration when the resistance value acquired by the measurement portion 82 becomes lower than the reference resistance value, or may also determine that there is ink penetration when the resistance value becomes lower than a predetermined threshold.

FIG. 6 is a diagram obtained by viewing the liquid ejection head substrate 1 in an A-A cross section (cross section perpendicular to the third direction D3) of FIG. 5. FIG. 6 illustrates the flow path formation substrate 6 of the liquid ejection head substrate 1 and the diaphragm 7 and the piezoelectric element 13 of the element substrate 8.

The piezoelectric element 13 is configured to include a lower electrode 106 in contact with the diaphragm 7, a piezoelectric film 107 placed on the lower electrode 106, and an upper electrode 108 placed on the piezoelectric film 107. The piezoelectric film 107 and the upper electrode 108 are patterned in a rectangular shape elongated in the second direction D2. In addition, the piezoelectric element 13 is covered with an insulating layer 109 intended for moisture prevention and insulation.

To apply a voltage to the upper electrode 108 and the lower electrode 106, the insulating layer 109 is provided with two openings, which are an opening portion 110 and an opening portion 111. The lower electrode 106 is an electrode layer to which the first drive wire 112 is connected via the opening portion 110. The upper electrode 108 is an electrode layer to which the second drive wire 113 is electrically connected via the opening portion 111. The first drive wire 112 and the second drive wire 113 are connected to respective mounting terminals (not shown). In addition, the piezoelectric element 13, the first drive wire 112, and the second drive wire 113 are covered with a protection layer 114 intended for moisture prevention and insulation from above the insulating layer 109. In other words, on the insulating layer 109, the protection layer 114 is stacked, and the insulating layer 109 is covered with the protection layer 114.

A place where ink penetration is likely to start is the communication port 15 formed in an interface between the element substrate 8 and the flow path formation substrate 6. Accordingly, the sensing wire for sensing ink is preferably placed therearound. In the first example embodiment, the first sensing wire 301 and the second sensing wire 302 are placed so as to surround the periphery of the rectangular communication port 15 except for a portion thereof when viewed in the first direction D1. A gap portion E of the communication port 15, which is not surrounded by the sensing wires, is provided opposite to the piezoelectric element 13 with respect to the communication port 15 in the second direction D2, i.e., in a portion corresponding to a side more distant from the piezoelectric element 13. The sensing wires placed so as to surround the one communication port 15 further extend so as to similarly surround the communication port 15 adjacent to the already surrounded communication port 15 in the third direction D3.

In addition, at positions overlapping the communication ports 15 when viewed in the first direction D1, the individual flow paths 10 are formed. The first sensing wire 301 and the second sensing wire 302 are placed on the diaphragm 7 formed with the communication ports 15, and the individual flow paths 10 are also located over the communication ports 15. In other words, when viewed in the first direction D1, the first sensing wire 301 and the second sensing wire 302 surround also the periphery of each of the individual flow paths 10 except for a portion thereof.

Note that, in the first example embodiment, portions of the communication ports 15 are not surrounded by the sensing wires, but each of the communication ports 15 may also be configured such that the entire periphery thereof is surrounded by the sensing wires. To provide a configuration in which the entire periphery of the communication port 15 is surrounded, it may also be possible that, e.g., the sensing wires to be placed around the communication port 15 and a connection wire extending in the third direction D3 to connect the individual sensing wires are formed in different layers. More specifically, it may also be possible to form the connection wire of a layer lower than that of the protection layer 114, open a portion of the protection layer 114, and connect the connection wire to the first sensing wire 301 and the second sensing wire 302 via the resulting opening.

The sensing wires need not necessarily be placed so as to surround the periphery of the communication port 15. When it is only intended to prevent penetration into the piezoelectric element 13, in the second direction D2, the first sensing wire 301 and the second sensing wire 302 need only to be provided between the piezoelectric element 13 and the communication port 15. In other words, when an ink penetration path is limited, the first sensing wire 301 and the second sensing wire 302 need only to be placed between the piezoelectric element 13 and the communication port 15 in the middle of the penetration path. To prevent penetration of the ink into the drive wires, the first sensing wire 301 and the second sensing wire 302 need only to be placed between the drive wire and the communication port 15.

While, in the first example embodiment, the first sensing wire 301 and the second sensing wire 302 are formed on the protection layer 114, i.e., on a junction surface with the flow path formation substrate 6, the sensing wires are not limited to such a configuration. In other words, the sensing wires need only to be placed at positions where the sensing wires can sense ink penetration before the ink reaches the piezoelectric elements 13 or the drive wires. Specifically, the sensing wires may also be formed, e.g., between the protection layer 114 and the insulating layer 109 or between the diaphragm 7 and the insulating layer 109.

In the first example embodiment, to detect ink penetration on the basis of a resistance change, the first sensing wire 301 and the second sensing wire 302 need to be formed of a material that does not undergo a resistance change even when the wires come into contact with the ink. For example, a corrosion-resistant material that is not dissolved even when coming into contact with a liquid such as ink is preferred and, specifically, Ta, Nb, or a precious metal such as Au, Ir, or Pt is used preferably, but the material is not limited thereto. Alternatively, the first sensing wire 301 and the second sensing wire 302 may also be formed of different materials as long as the materials satisfy the condition described above.

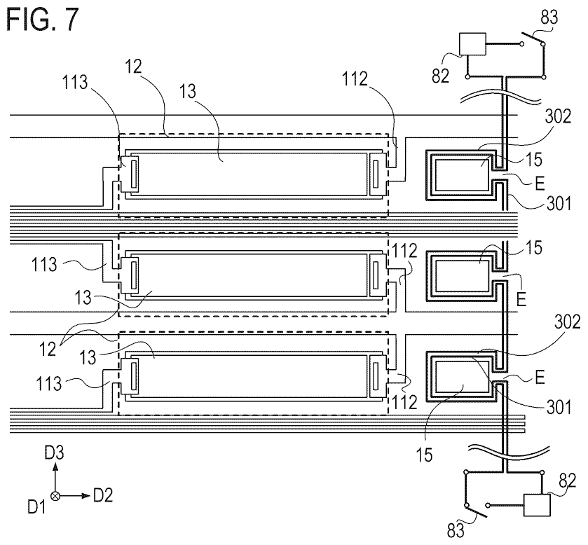

In addition, in the first example embodiment, a configuration in which the pair of the first sensing wire 301 and the second sensing wire 302 are provided is used, but it may also be possible to provide larger numbers of the first sensing wires 301 and the second sensing wires 302. FIG. 7 is a plan view illustrating the periphery of some of the piezoelectric elements 13 of the element substrate 8 according to a modification, which is a view when the element substrate 8 is viewed in the first direction D1.

In the present modification, the different first sensing wires 301 and the different second sensing wires 302 are placed around the two communication ports 15 arranged with the second drive wires 113 being interposed therebetween. By using a configuration in which the plurality of first sensing wires 301 and the plurality of second sensing wires 302 are thus provided, it is possible to sense ink penetration for, e.g., each of blocks, i.e., for each of predetermined ranges. By using such a configuration, when ink penetration is sensed in a given block, it is possible to stop ejection in that block, change an ejection signal such that another block complements the block, and allow printing to be continued. In other words, by providing the plurality of sensing wires corresponding to the plurality of respective piezoelectric elements 13 and a plurality of the measurement portions 82 corresponding to the plurality of respective sensing wires, when ink penetration is sensed, it is possible to continuously perform a printing operation, while preventing occurrence of defective printing due to the defective ejection.

Thus, with the configuration in the first example embodiment, it is possible to sense the ink penetration into the element substrate 8, and therefore it is possible to prevent occurrence of the defective ejection and prevent quality deterioration of deliverables.

### Second Example Embodiment

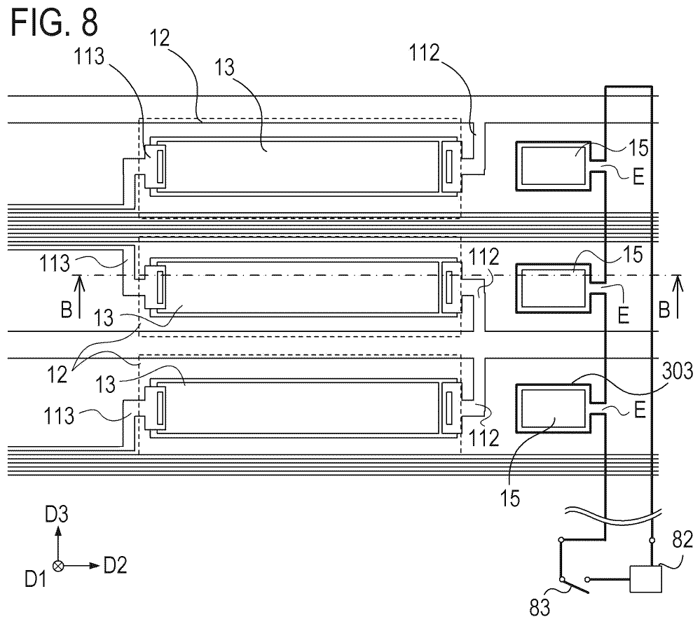

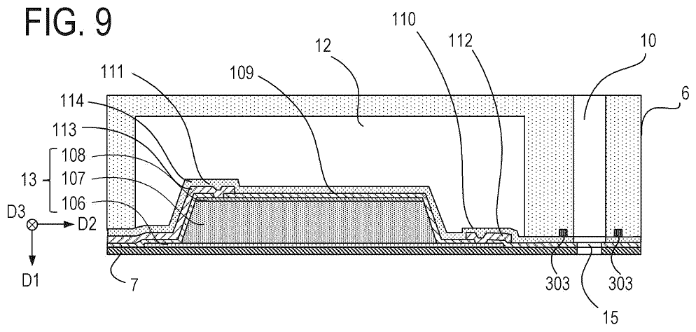

Referring to FIGS. 8 and 9, a description will be given of a second example embodiment including an ink penetration sensing configuration. FIG. 8 is a plan view illustrating the periphery of some of the piezoelectric elements 13 of the element substrate 8 according to the second example embodiment, which is a view when the element substrate 8 is viewed in the first direction D1. Note that, in FIG. 8, to clearly show positional relationships among individual members such as wires, illustration of some of the members, such as the protection film, is omitted. In addition, in FIG. 8, the positions of the cavities 12 in the flow path formation substrate 6 are indicated by the dotted lines. FIG. 9 is a view obtained by viewing the liquid ejection head substrate 1 in a B-B cross section (cross section perpendicular to the third direction D3) in FIG. 8. FIG. 8 illustrates the flow path formation substrate 6 of the liquid ejection head substrate 1 and the diaphragm 7 and the piezoelectric elements 13 of the element substrate 8.

In the second example embodiment, instead of the first sensing wire 301 and the second sensing wire 302 in the first example embodiment, one sensing wire 303 is provided. The sensing wire 303 is formed of a metal material which is dissolved by contact with the liquid (ink).

The sensing wire 303 is placed so as to surround the periphery of the rectangular communication port 15 except for a portion thereof when viewed in the first direction D1. The gap portion E of the communication port 15 which is not surrounded by the sensing wire 303 is provided opposite to the piezoelectric element 13 with respect to the communication port 15 in the second direction D2, i.e., in a portion corresponding to a side more distant from the piezoelectric element 13. The sensing wire placed so as to surround the one communication port 15 further extends so as to similarly surround the communication port 15 adjacent to the already surrounded communication port 15 in the third direction D3. In other words, the sensing wire 303 is placed so as to surround the peripheries of the plurality of communication ports 15.

Both ends of the sensing wire 303 are connected to different electrode pads. To the sensing wire 303, the measurement portion 82 capable of measuring a resistance of the sensing wire 303 via the electrode pads is connected.

The resistance value measured via the electrode pads when the sensing wire 303 is not in contact with the ink is assumed to be the reference resistance value. When the ink has not penetrated the element substrate 8 and the sensing wire 303 is not in contact with the ink, the value acquired by the measurement portion 82 is the reference resistance value.

Meanwhile, when the ink comes into contact with the sensing wire 303, the sensing wire 303 is dissolved to reduce a cross-sectional area of a conducting portion thereof, and accordingly the resistance value acquired by the measurement portion 82 becomes larger than the reference resistance value. Therefore, in the configuration of the second example embodiment, the resistance value of the sensing wire 303 is continuously measured and, when the resistance value increases, it can be determined that the ink has penetrated the element substrate 8.

A material of the sensing wire 303 is selected from among materials that are relatively corrosive to the ink. To sense ink penetration at an early stage, it is appropriate to select among more easily soluble materials. Specifically, a metal material that is dissolved by contact with ink containing aluminum, tungsten, zinc, or the like can be used.

When a dissolution speed of the sensing wire 303 is low, sensing timing may be delayed. Therefore, it may also be possible to use a configuration in which a positive potential is constantly applied to the sensing wire 303 so as to increase the dissolution speed during contact with the ink and positively cause anodic dissolution.

While the both ends of the sensing wire 303 are connected to the electrode pads in the second example embodiment, it may also be possible to additionally connect a middle portion of the sensing wire 303 to the electrode pads and allow the resistance value to be measured in each of predetermined ranges. By thus configuring the sensing wire 303 so as to allow the resistance value to be measured in each of the predetermined ranges, it is possible to specify an ink penetration location. Then, the ejection at the ink penetration location is stopped, and the ejection signal is changed to allow another block to complement a block with the ink penetration and allow printing to be continued.

Next, a description will be given of each of verification examples in which, for the individual example embodiments described above, the liquid ejection heads 42 were actually produced, an evaluation test was performed on each of the liquid ejection heads 42, and an effect thereof was verified.

### First Verification Example

First, in the first verification example, using Au, the first sensing wire 301 and the second sensing wire 302 in the first example embodiment were formed to a thickness of 2 μm and patterned. The first sensing wire 301 and the second sensing wire 302 were formed on the protection layer 114. As illustrated in FIG. 5, the first sensing wire 301 and the second sensing wire 302 were routed so as to surround all the communication ports 15, while maintaining a parallel state therebetween. A distance between the first sensing wire 301 and the second sensing wire 302 was set to 5 μm. The respective end portions of the wires are connected to the electrode pads to allow the measurement portion 82 to measure the resistance between the first sensing wire 301 and the second sensing wire 302. Then, by forming other necessary terminals and the like, the liquid ejection head 42 according to the first example embodiment was produced.

### Print Durability Evaluation Test

A description will be given of a print durability evaluation test performed on the liquid ejection head 42 according to the first verification example. First, the switch 83 was closed, the resistance value between the first sensing wire 301 and the second sensing wire 302 was measured with the measurement portion 82, and it was confirmed that the resistance value was the reference resistance value and open.

Then, the liquid ejection head 42 was caused to execute (1×10\hat{ }12) ejecting operations. As the ink, water-based magenta ink was used. During the ejecting operations, the liquid ejection head 42 was subjected to temperature adjustment to reach 30° C. After the ejecting operations, the switch 83 was closed and, as a result of measuring the resistance between the first sensing wire 301 and the second sensing wire 302 with the measurement portion 82, it was confirmed that the obtained resistance value was the reference resistance value and open.

Subsequently, the execution of the (1×10\hat{ }12) ejecting operations and the measurement of the resistance value was alternately repeated and, in the measurement of the resistance value after the cumulative (5×10\hat{ }12)-th ejecting operation was completed, 10 MΩ was measured at 5 V, and a numerical value showing conduction was shown.

As a result of observing the liquid ejection head substrate 1 of the liquid ejection head 42 in this state with an IR microscope, it was found that the ink penetrated through any of the communication ports 15, and the gap between the first sensing wire 301 and the second sensing wire 302 was filled with the ink. Print evaluation was performed with the liquid ejection head 42 in this state, and a print quality had no problem.

Thereafter, additional (1×10\hat{ }12) ejecting operations were further executed, and a resistance value was measured, with the result that the resistance value further decreased to 5 kΩ at 5 V. When print evaluation was performed using the liquid ejection head 42 in this state, blurring was observed in some of the prints, and print quality deterioration was observed.

As a result of observing the liquid ejection head substrate 1 of the liquid ejection head 42 in this state with the IR microscope, it was found that the ink had reached the drive wire portions beyond the first sensing wire 301 and the second sensing wire 302, and the drive wires were partly damaged. Then, when the flow path formation substrate 6 was peeled from the element substrate 8 and a surface of the element substrate 8 was further observed in detail with the optical microscope, it was found that the diaphragm 7 was broken around the communication port 15.

Therefore, with the configuration in the first verification example, at the time when the measurement portion 82 measures the resistance value of 10 MΩ, it is possible to sense ink penetration into the element substrate 8 and replace the liquid ejection head 42 before deterioration of a print quality occurs. Consequently, it is possible to prevent wasteful deliverables with deteriorated print quality from being produced.

### Second Verification Example

Next, in the second verification example, the sensing wire 303 in the second example embodiment was formed using AlCu to a thickness of 600 m and patterned. The sensing wire 303 was formed between the protection layer 114 and the insulating layer 109. As illustrated in FIG. 8, the sensing wire 303 was routed so as to surround all the communication ports 15. Both ends of the sensing wire 303 were connected to electrode pads to allow the measurement portion 82 to measure the resistance values thereof. Then, by forming other necessary terminals and the like, the liquid ejection head 42 was produced.

### Print Evaluation Test

A description will be given of a print durability evaluation test performed on the liquid ejection head 42 according to the second verification example. First, the switch 83 was closed, and a resistance of the sensing wire 303 was measured with the measurement portion 82. A value obtained by adding a measurement tolerance to the initial measurement value was assumed to be an upper limit value Rt of the reference resistance value.

Then, the liquid ejection head 42 was caused to execute (1×10\hat{ }12) ejecting operations. As the ink, a water-based primer ink was used. During the ejecting operations, the liquid ejection head 42 was subjected to temperature adjustment to reach 30° C. After the ejecting operations, the switch 83 was closed and, as a result of measuring the resistance of the circuit including the sensing wire 303 with the measurement portion 82, it was confirmed that the obtained resistance value was not more than the upper limit value Rt.

Subsequently, the execution of the (1×10\hat{ }12) ejecting operations and the measurement of the resistance value was alternately repeated and, in the measurement of the resistance value after the cumulative (4×10\hat{ }12)-th ejecting operation was completed, the resistance value showed a value which was 1.3 times the upper limit value Rt.

As a result of observing the liquid ejection head substrate 1 of the liquid ejection head 42 in this state with an IR microscope, it was found that the ink penetrated through any of the communication ports 15, and the sensing wire 303 was corroded by the ink. Print evaluation was performed with the head in this state, and a print quality had substantially no problem.

Thereafter, additional (1×10\hat{ }12) ejecting operations were further executed, and a resistance value was measured, with the result that the resistance value further increased to a resistance value which was five times the upper limit value Rt. When print evaluation was performed using the liquid ejection head 42 in this state, blurring was observed in some of the prints, and print quality deterioration was observed.

As a result of observing the liquid ejection head substrate 1 of the liquid ejection head 42 in this state with the IR microscope, it was found that the ink had reached the drive wire portions beyond the sensing wire 303, and the drive wires were partly damaged. Then, when detailed observation was further performed, it was found that a bottom surface of the flow path formation substrate 6 was oxidized, and floating occurred at the interface with the element substrate 8.

Therefore, with the configuration in the second verification example, at the time when the measurement portion 82 measures the resistance value which is five times the upper limit value Rt, it is possible to sense ink penetration into the element substrate 8 and replace the liquid ejection head 42 before deterioration of a print quality occurs due to the defective ejection. Consequently, it is possible to prevent wasteful deliverables with deteriorated print quality from being produced.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-125777, filed Aug. 1, 2024, which is hereby incorporated by reference herein in its entirety.

What is claimed is:

1. A liquid ejection head comprising:
an ejection port from which a liquid is to be ejected;
a first substrate including a liquid chamber communicating with the ejection port and having a communication port, through which the liquid to be supplied to the liquid chamber passes, and an energy generation element that generates energy for ejecting the liquid from the ejection port;
a second substrate joined to the first substrate, the second substrate having a flow path communicating with the communication port of the liquid chamber; and
a sensing wire for sensing penetration of the liquid to an interface between the first substrate and the second substrate, the sensing wire being provided between the energy generation element and the communication port in a second direction parallel to a surface of the second substrate as viewed in a first direction corresponding to a direction in which the first substrate and the second substrate are stacked in layers.

2. The liquid ejection head according to claim 1,
wherein, as viewed in the first direction, the sensing wire is placed so as to surround a periphery of the communication port, except for a portion thereof.

3. The liquid ejection head according to claim 2,
wherein a gap portion, which is not surrounded by the sensing wire, of the communication port is disposed on an opposite side of the communication port to the energy generation element in the second direction.

4. The liquid ejection head according to claim 1, further comprising:
a second sensing wire electrically insulated from a first sensing wire in a case where the sensing wire is defined as the first sensing wire,
wherein the second sensing wire is provided side by side with the first sensing wire in the second direction at least between the energy generation element and the communication port.

5. The liquid ejection head according to claim 1, further comprising:
a plurality of the energy generation elements; and
the sensing wire corresponding to the plurality of energy generation elements.

6. The liquid ejection head according to claim 1, further comprising:
a drive wire to be connected to the energy generation element,
wherein the sensing wire is placed between the drive wire and the communication port in the second direction.

7. The liquid ejection head according to claim 1,
wherein the sensing wire is placed on an outermost surface of the first substrate.

8. The liquid ejection head according to claim 1,
wherein the first substrate includes an insulating layer covering the energy generation element and a protection layer covering the insulating layer, and
wherein the sensing wire is formed between the insulating layer and the protection layer.

9. The liquid ejection head according to claim 1,
wherein the first substrate includes a diaphragm, on which the energy generation element is to be placed, and an insulating layer covering the energy generation element, and
wherein the sensing wire is formed between the diaphragm and the insulating layer.

10. The liquid ejection head according to claim 1,
wherein, in the first substrate, a plurality of the energy generation elements and a plurality of the communication ports are provided to be arranged in a third direction crossing each of the first direction and the second direction, and
wherein the sensing wire is placed between the plurality of energy generation elements and the plurality of communication ports in the second direction.

11. The liquid ejection head according to claim 10,
wherein the sensing wire is provided to correspond to the plurality of communication ports.

12. The liquid ejection head according to claim 1,
wherein an outer edge portion of the communication port is joined to the first substrate.

13. The liquid ejection head according to claim 1, further comprising:
a third substrate joined to the first substrate and having a plurality of the ejection ports formed therein.

14. The liquid ejection head according to claim 1,
wherein the energy generation element has a rectangular shape as viewed in the first direction, and the second direction is parallel to a longitudinal direction of the energy generation element.

15. The liquid ejection head according to claim 1,
wherein the energy generation element is a piezoelectric element placed on a junction surface of the first substrate with the second substrate.

16. The liquid ejection head according to claim 1,
wherein the sensing wire contains at least any of Ta, Nb, Au, Ir, and Pt.

17. The liquid ejection head according to claim 1,
wherein the sensing wire contains at least any of aluminum, tungsten, and zinc.

18. A liquid ejection apparatus comprising:
an ejection port from which a liquid is to be ejected;
a first substrate including a liquid chamber communicating with the ejection port and having a communication port, through which the liquid to be supplied to the liquid chamber passes, and an energy generation element that generates energy for ejecting the liquid from the ejection port;
a second substrate joined to the first substrate, the second substrate having a flow path communicating with the communication port of the liquid chamber;
a sensing wire for sensing penetration of the liquid to an interface between the first substrate and the second substrate, the sensing wire being provided between the energy generation element and the communication port in a second direction parallel to a surface of the second substrate as viewed in a first direction corresponding to a direction in which the first substrate and the second substrate are stacked in layers; and
a measurement portion that measures a resistance value of a circuit including the sensing wire.

19. The liquid ejection apparatus according to claim 18, further comprising:
a second sensing wire electrically insulated from a first sensing wire in a case where the sensing wire is assumed to be the first sensing wire,
wherein the second sensing wire is provided side by side with the first sensing wire in the second direction at least between the energy generation element and the communication port,
wherein a material of the sensing wire is a corrosion-resistant metal material that is not dissolved by contact with ink, which is the liquid ejected from the ejection port, and
wherein the measurement portion measures a resistance value between the first sensing wire and the second sensing wire.

20. The liquid ejection apparatus according to claim 18,
wherein a material of the sensing wire is a metal material that is corroded by contact with ink, which is the liquid ejected from the ejection port, and
wherein the measurement portion measures a resistance value of the sensing wire.
